(19) United States
(12) Patent Application Publication
(10) Pub. No.: US 2014/0337742 A1
(43) Pub. Date: Nov. 13, 2014

(54) METHOD, AN APPARATUS AND A COMPUTER PROGRAM FOR DETERMINATION OF AN AUDIO TRACK

(71) Applicant: Nokia Corporation, Espoo (FI)

(72) Inventors: Roope Olavi Järvinen, Lempaala (FI); Kari Juhani Järvinen, Tampere (FI); Juha Henrik Arrasvuori, Tampere (FI); Miikka Vilermo, Siuro (FI)

(21) Appl. No.: 14/365,597

(22) PCT Filed: Dec. 22, 2011
(86) PCT No.: PCT/FI2011/051150

§ 371 Date: Jun. 13, 2014

(51) Int. Cl. G06F 3/16; G06F 3/0484; G06F 17/30

(52) U.S. Cl. CPC G06F 3/165; G06F 17/3074; G06F 3/0484
USPC 715/732

(57) ABSTRACT

An audio processing apparatus is provided. The apparatus comprising an audio analysis unit configured to obtain a group of audio signals, each audio signal associated with an image of a group of images, the group of images being provided for a presentation having an assigned overall viewing time with each image having an assigned viewing time, and to analyze at least one of the audio signals to determine one or more intermediate audio signals for determination of an audio track having a first duration, which first duration essentially covers said assigned overall viewing time. The apparatus further comprises an audio track determination unit configured to compose the audio track having said first duration on basis of said one or more intermediate audio signals. The apparatus may further comprise a classification unit configured to obtain a plurality of audio signals, each audio signal associated with an image of a plurality of images, to obtain a plurality of location indicators, each location indicator associated with an image of the plurality of images, and to determine the group of images as a subset of the plurality of images such that the group comprises images having location indicator referring to a first location associated therewith.

### TECHNICAL FIELD

The invention relates to a method, to an apparatus and to a computer program for determining and/or composing an audio track. In particular, the invention relates to determination, preparation or composition of an audio track usable to accompany a presentation of a plurality of images to a user sequentially (e.g. as a slideshow), combined into an aggregate image (e.g. as a panorama image) or in any other suitable way.

### BACKGROUND

Modern imaging devices, such as digital cameras and mobile phones equipped with a digital camera or a camera module may have a capability to detect their location using global positioning system (GPS). Moreover, such devices may be capable of determining the current location upon capture of an image and to associating the determined current location with the captured image. Such devices may further have a capability to record an audio signal at the time of capture of an image and to store the captured audio signal with the captured image.

### SUMMARY

According to a first aspect of the present invention, an apparatus is provided, the apparatus comprising an audio analysis unit configured to obtain a group of audio signals, each audio signal associated with an image of a group of images, the group of images being provided for a presentation having an assigned overall viewing time with each image having an assigned viewing time, and to analyze at least one of the audio signals to determine one or more intermediate audio signals for determination of an audio track having a first duration, which first duration essentially covers said assigned overall viewing time. The apparatus further comprises an audio track determination unit configured to compose the audio track having said first duration on basis of said one or more intermediate audio signals.

The apparatus may further comprise a classification unit configured to obtain a plurality of audio signals, each audio signal associated with an image of a plurality of images, to obtain a plurality of location indicators, each location indicator associated with an image of the plurality of images, and to determine the group of images as a subset of the plurality of images such that the group comprises images having location indicator referring to a first location associated therewith.

According to a second aspect of the present invention, an apparatus is provided, the apparatus comprising at least one processor and at least one memory including computer program code for one or more programs, the at least one memory and the computer program code configured to, with the at least one processor, cause the apparatus at least to obtain a group of audio signals, each audio signal associated with an image of a group of images, the group of images being provided for a presentation having an assigned overall viewing time with each image having an assigned viewing time, to analyze at least one of the audio signals to determine one or more intermediate audio signals for determination of an audio track having a first duration, which first duration essentially covers said assigned overall viewing time; and to compose the audio track having said first duration on basis of said one or more intermediate audio signals.

According to a third aspect of the present invention, an apparatus is provided, the apparatus comprising means for obtaining a group of audio signals, each audio signal associated with an image of a group of images, the group of images being provided for a presentation having an assigned overall viewing time with each image having an assigned viewing time, means for analyzing at least one of the audio signals to determine one or more intermediate audio signals for determination of an audio track having a first duration, which first duration essentially covers said assigned overall viewing time, and means for composing the audio track having said first duration on basis of said one or more intermediate audio signals.

According to a fourth aspect of the present invention, a method is provided, the method comprising obtaining a group of audio signals, each audio signal associated with an image of a group of images, the group of images being provided for a presentation having an assigned overall viewing time with each image having an assigned viewing time, analyzing at least one of the audio signals to determine one or more intermediate audio signals for determination of an audio track having a first duration, which first duration essentially covers said assigned overall viewing time, and composing the audio track having said first duration on basis of said one or more intermediate audio signals.

According to a fifth aspect of the present invention, a computer program is provided, the computer program including one or more sequences of one or more instructions which, when executed by one or more processors, cause an apparatus at least to obtain a group of audio signals, each audio signal associated with an image of a group of images, the group of images being provided for a presentation having an assigned overall viewing time with each image having an assigned viewing time, to analyze at least one of the audio signals to determine one or more intermediate audio signals for determination of an audio track having a first duration, which first duration essentially covers said assigned overall viewing time, and to compose the audio track having said first duration on basis of said one or more intermediate audio signals.

The computer program may be embodied on a volatile or a non-volatile computer-readable record medium, for example as a computer program product comprising at least one computer readable non-transitory medium having program code stored thereon, the program which when executed by an apparatus cause the apparatus at least to perform the operations described hereinbefore for the computer program according to the fifth aspect of the invention.

An advantage of the method, apparatuses and the computer program according to various embodiments of the invention is that they provide a flexible and automated or partially automated composition of an audio track to accompany a presentation of a plurality of images based on analysis of an item or items of further data associated with images of the plurality of images.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

The novel features which are considered as characteristic of the invention are set forth in particular in the appended claims. The invention itself, however, both as to its construction and its method of operation, together with additional objects and advantages thereof, will be best understood from the following detailed description of specific embodiments when read in connection with the accompanying drawings.

### BRIEF DESCRIPTION OF FIGURES

FIG. 1 schematically illustrates an audio processing apparatus in accordance with an embodiment of the invention.

FIG. 2a schematically illustrates a basic idea of presenting a plurality of images as a slide show, accompanied by an audio track.

FIG. 2b schematically illustrates a basic idea of presenting a plurality of images as portions of an aggregate image, accompanied by an audio track.

FIG. 3 schematically illustrates an example of composing an audio track in accordance with an embodiment of the invention.

FIG. 4 schematically illustrates an example of composing an audio track in accordance with an embodiment of the invention.

FIG. 5 schematically illustrates an example of composing an audio track in accordance with an embodiment of the invention.

FIG. 6 schematically illustrates an example of composing an audio track in accordance with an embodiment of the invention.

FIG. 7 schematically illustrates an example of composing an audio track in accordance with an embodiment of the invention.

FIG. 8 illustrates the concept of further data associated with an image.

FIG. 9 illustrates a principle of the pre-record function.

FIG. 10 illustrates a method in accordance with an embodiment of the invention.

FIG. 11 illustrates a method in accordance with an embodiment of the invention.

FIG. 12 illustrates a method in accordance with an embodiment of the invention.

FIG. 13 illustrates a method in accordance with an embodiment of the invention.

FIG. 14 illustrates a method in accordance with an embodiment of the invention.

FIG. 15 schematically illustrates an apparatus in accordance with an embodiment of the invention.

### DETAILED DESCRIPTION

An image may have an audio signal associated therewith. An audio signal may also be referred to as an audio clip, an audio sample, etc. The audio signal may be monaural, stereophonic, or multi-channel audio signal. There may also be further audio-related information characterizing the audio signal associated with an image. Such further audio-related information may comprise for example information on applied sampling frequency, on number of channels and/or on channel configuration of the audio signal. As another example, the further audio-related information may comprise an indication of the type of an audio signal, indicating for example that the audio signal comprises a specific signal component, such as voice or speech signal component, music, ambient signal component only, a spatial audio signal component, or information otherwise characterizing the type of the audio signal. As yet further examples, the further audio-related information may indicate the duration, i.e. the temporal length, of an audio signal and/or a direction of arrival associated with a spatial audio signal. Such further audio-related information characterizing the audio signal may be determined based on pre-analysis of the audio signal.

An audio signal together with possible further audio-related information may be referred to as an audio item. In the following, various embodiments of the invention are described with a reference to an audio signal associated with an image. However, the description can be generalized into an audio item associated with an image, hence directly implying that the audio signal is accompanied by further audio-related information that can be made use of in the analysis of the audio signal/item.

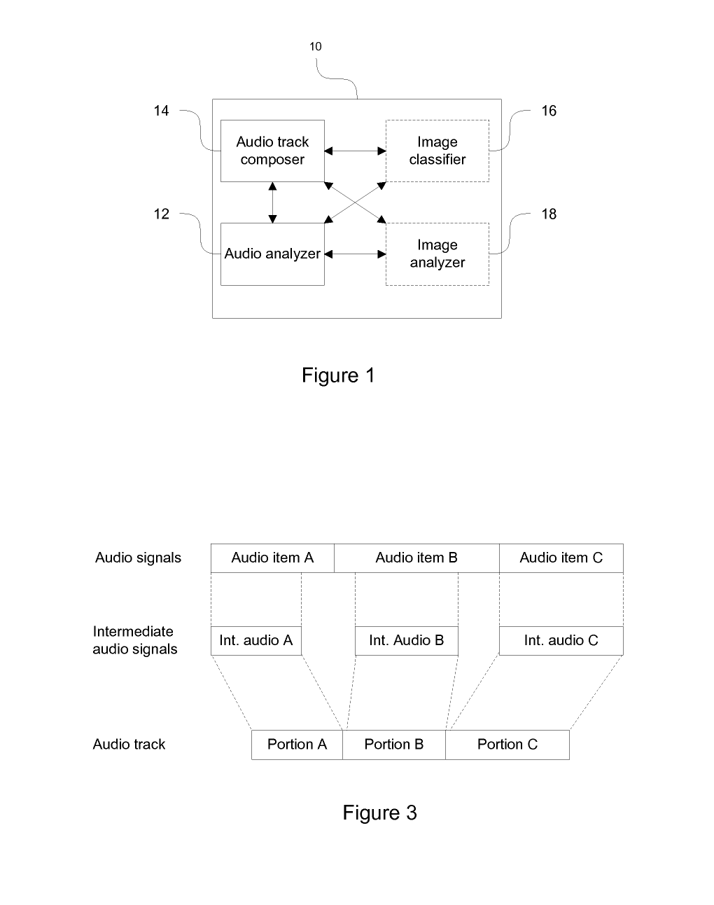

FIG. 1 schematically illustrates an audio processing apparatus 10 in accordance with an embodiment of the invention. The apparatus 10 comprises an audio analysis unit 12 and an audio track determination unit 14, operatively coupled to the audio analysis unit 12. The apparatus 10 may further comprise a classification unit 16, operatively coupled to the audio analysis unit 12 and/or to the audio track determination unit 14. The apparatus 10 may further comprise image analysis unit 18, operatively coupled to the audio analysis unit 12 and/or to the audio track determination unit 14. The units operatively coupled to each other may be configured and/or enabled to exchange information and/or instructions therebetween.

The audio analysis unit 12 may also be referred to as an audio analyzer. The audio track determination unit 14 may also be referred to as an audio track determiner or an audio track composer. The classification unit 16 may be also referred to as a classifier or an image classifier. The image analysis unit 18 may also be referred to as an image analyzer.

The audio analysis unit 12 is configured to obtain a group of audio signals, each audio signal associated with an image of a group of images. The group of images may be provided for example for composing a presentation having an assigned overall viewing time with each image having an assigned viewing time. The group of audio signals may comprise one or more audio signals.

The audio analysis unit 12 is further configured to analyze at least one of the audio signals of the group of audio signals in order to determine one or more intermediate audio signals that may be used for determination of an audio track having a desired duration. The audio analysis unit 12 may be further configured to provide the one or more intermediate audio signals to the audio track determination unit 14.

The audio track determination unit 14 is configured to determine or to compose an audio track having said desired duration on basis of said one or more intermediate audio signals determined based on analysis of one or more of the audio signals of the group of audio signals. The audio track preferably has a duration that covers or essentially covers the overall viewing time assigned for the presentation of the group of images.

The term ‘essentially covers’ is in this context used to indicate an audio track having a duration that is equal to or longer than the assigned overall viewing time of the group of images. In other words, preferably an audio track having duration that is no shorter than the assigned overall viewing time of the group of images is determined.

As an example, the audio track determination unit 14 may be configured to compose an audio track or a portion thereof on basis of a number of intermediate audio signals for example by concatenating one or more of the intermediate audio signals in order to have an audio track of desired length. As another example, the audio track determination unit 14 may be configured to compose an audio track or a portion thereof by mixing two or more of the intermediate audio signals, e.g. by summing or averaging respective samples of two or more intermediate audio signals to have an audio track with desired audio signal characteristics. As yet further examples the audio track determination unit 14 may be configured to compose an audio track or a portion thereof by repeating and/or partially repeating, e.g. “looping”, an intermediate audio signal in order to have an audio track of desired length, or it may be configured to compose an audio track or a portion thereof by adjusting signal level of an intermediate audio signal to have desired audio signal characteristics.

The apparatus 10 may comprise further components, such as a processor, a memory, a user interface, a communication interface, etc.

The audio track determination unit 12 may be configured to obtain an audio signal for example by reading the audio signal from a memory of the apparatus 10 or by receiving the audio signal from another apparatus via a communication interface.

The audio analysis unit 12 and/or the audio determination unit 14 may be further configured to obtain the assigned viewing times for images of the group of images. In particular, the audio analysis unit 12 or the audio track determination unit 14 may be configured to obtain an assigned viewing time for an image of the group of images for example by reading the respective assigned viewing time from a memory of the apparatus 10 or by receiving the respective assigned viewing time from another apparatus via a communication interface. As a further example, the respective assigned viewing time may be received as an input from a user via a user interface. The respective assigned viewing time by determining the assigned viewing time for a given image may be determined to be equal to the duration, i.e. the temporal length, of an audio signal associated with the given image. As a yet further example, the audio analysis unit 12 or the audio track determination unit 14 may be configured to obtain an assigned overall viewing time for the group of images and to obtain an assigned viewing time for a given image by determining the assigned viewing time on basis of the assigned overall viewing time of the group of images, e.g. as the assigned overall viewing time divided by the number of images in the group of images.

The assigned viewing time may also be referred to as an assigned display time, an assigned presentation time, etc. The assigned viewing time determines the temporal location of the image in relation to the assigned overall viewing time of the group of images. The assigned viewing time for a given image may determine the assigned beginning and ending times with respect to a reference point of time. Alternatively, the assigned viewing time for a given image may determine the assigned beginning time for presenting the given image with respect to a reference point of time together with an assigned viewing duration for the given image. The reference point of time may be for example the start of the viewing/displaying/representing the group of images, for example the start of viewing the first image of the group of images.

The audio analysis unit 12 and/or the audio determination unit 14 may be further configured to obtain or determine the assigned overall viewing time of the group of images. As an example, the assigned overall viewing time of the group of images may be determined as a sum of assigned viewing times of the images of the group of images. As another example, the assigned overall viewing time for the group of images may be determined on basis of the number of images in the group of images, e.g. by assigning a predetermined equal viewing time for each image of the group of images. As a further example, the assigned overall viewing time may be determined on basis of input from the user received from the user interface.

Images of the group of images may be for example photographs, drawings, graphs, computer generated images, etc. Some or all images of a group of images may originate from or may be arranged into a video sequence, thereby possibly constituting a sequence of images within the group of images. In particular, a group of images comprising such a sequence of images may represent a cinemagraph.

The determined audio track may be arranged to accompany a presentation of the group of images. The images may be presented to a user for example as a slide show or as portions of an aggregate image composed on basis of a number of images. An example of an aggregate image is a panorama image.

Here a slide show refers to presenting a plurality of images sequentially, e.g. one by one. Each image presented in the slide show may be presented for a predetermined period of time, referred to as an assigned viewing time. The assigned viewing time for a given image may be set as a fixed period of time that is equal or substantially equal for each image. Alternatively, the assigned viewing time may vary from image to image. Moreover, the presentation may have an assigned overall viewing time.

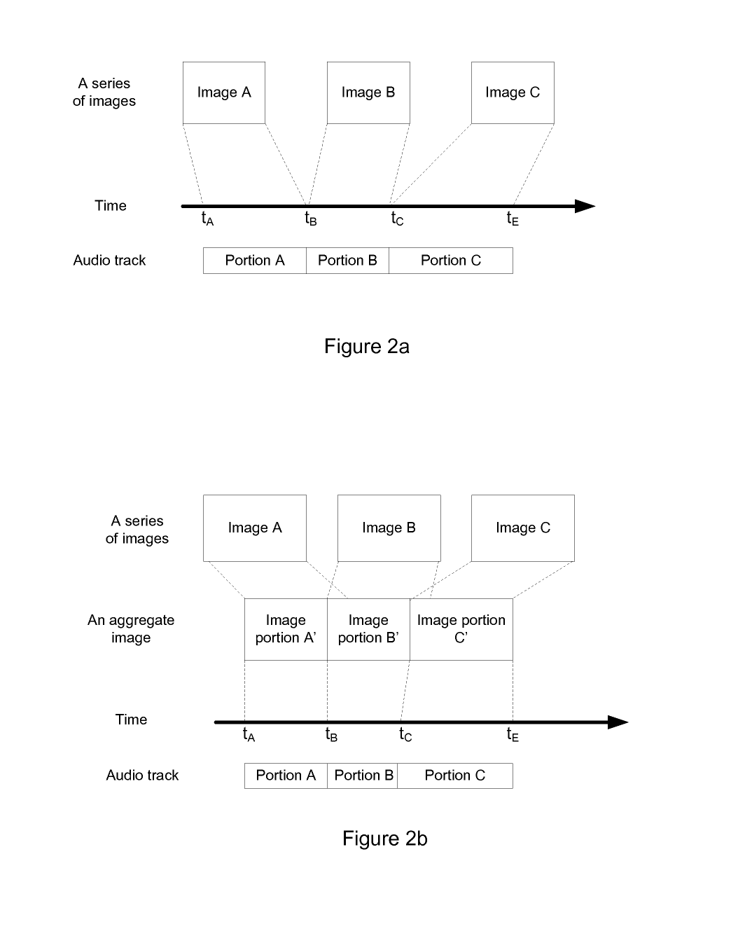

FIG. 2a illustrates an example of the basic idea of presenting a number of images, i.e. images A, B and C as a slide show, accompanied by an audio track. The assigned overall viewing time of the number of images covers the time from t_{A} until t_{E}. FIG. 2a also illustrates an audio track, also covering the assigned overall viewing time of the number of images. The image A is presented starting at t_{A} until t_{B}, this duration covering the assigned viewing time of image A, the same period of time being also covered by portion A of the audio track. The image B is presented starting at t_{B} until t_{C}, and the image C is presented starting at t_{C} until t_{E}, hence covering the assigned viewing times of images B and C, respectively. The assigned viewing times of images B and C are, respectively, covered by portions B and C of the audio track.

In case the number of images or a subset thereof represents a cinemagraph, the images may be presented in a similar manner as described hereinbefore for the number of images presented as a slide show. In case the number of images comprises a sequence of images constituting a video sequence of images, there may be a dedicated assigned viewing time for each image of the video sequence, or there may be a single assigned viewing time for the video sequence.

An aggregate image may be composed as a combination of two or more images, thereby forming a larger composition image. A particular example of an aggregate image is a panorama image. A panorama image typically requires that the images to be combined into a panorama image represent a different view to two or more different directions from the same or from essentially the same location. A panorama image may be composed based on such images by processing or analyzing the images in order to find matching patterns in the edge areas of the images representing view to adjacent directions and combining these images to form a uniform combined image representing the two adjacent directions. The process of combining the images may involve removing overlapping parts in the edge areas of one or both of the images representing the two adjacent directions. An aggregate image may be presented to a user such that during a given period of time only a portion of the aggregate image is shown, with the portion of the aggregate image currently shown to the user being changed according to a predetermined pattern

FIG. 2b illustrates an example of the basic idea of presenting a number of images, i.e. images A, B and C as portions of an aggregate image, accompanied by an audio track. The images A, B and C are combined into an aggregate image having image portions A′, B′ and C′. The assigned overall viewing time of the number of images formed by the image portions A′, B′ and C′ covers the time from t_{A} until t_{E}. The image portion A′ is presented starting at t_{A} until t_{B}, this duration covering the assigned viewing time of image portion A′, the same period of time being also covered by portion A of the audio track. The image portion B′ is presented starting at t_{B} until t_{C}, and the image portion C′ is presented starting at t_{C} until t_{E}, hence covering the assigned viewing times of image portions B′ and C′, respectively. The assigned viewing times of image portions B′ and C′ are, respectively, covered by portions B and C of the audio track.

The audio track preferably has a duration that is equal or substantially equal to the assigned overall viewing time of the number of images forming the presentation. The audio track implicitly or explicitly comprises a number of portions, each portion temporally aligned with the assigned viewing time of a given image of the number of images, hence to be arranged for playback simultaneously or essentially simultaneously with the assigned viewing time of the given image.

The audio track composition unit 14 may be further configured to arrange the group of images and the determined audio track into a presentation of the group of images. The presentation may be arranged for example as a slide show or as a presentation of an aggregate image such as a panorama image.

The presentation may be arranged for example into a Microsoft PowerPoint presentation—or into a presentation using a corresponding presentation software/arrangement. Further examples of formats applicable for presentation include, MPEG-4, Adobe Flash, etc. or any other multimedia format that enables synchronized presentation of audio and images/video. Yet further, the images and the audio track may be arranged e.g. as a web page configured to present images and play back audio upon a user accessing the web page.

An image may have a location indicator associated therewith. The location indicator may also be called location information, location identifier, etc. The location indicator may comprise information determining a location associated with the image. For example in case of a photograph the location indicator may comprise information indicating the location in which the image was captured or it may comprise information indicating a location otherwise associated with an image. The location indicator may be provided based on a satellite-based positioning system, such as global positioning system (GPS) coordinates, as geographic coordinates (degree, minutes, seconds), as direction to and distance from a predetermined reference location, etc.

In accordance with an embodiment of the invention, the apparatus 10 may comprise the classification unit 16. The classification unit 16 may be configured to obtain a plurality of audio signals, each audio signal associated with an image of a plurality of images. The audio signals associated with the images of the plurality of images may be obtained as described hereinbefore.

The classification unit 16 may be further configured to obtain a plurality of location indicators, each location indicator associated with an image of the plurality of images. A location indicator may indicate the location associated with an image, and the location indicator may comprise GPS coordinates, geographic coordinates, information indicating a distance from and a direction to a predetermined reference location, etc.

The classification unit 16 may be further configured to determine a first group of images as a subset of the plurality of images such that the first group of images comprises images having location indicator referring to a first location associated therewith.

The location indicators associated with the images of the plurality of images may be used to divide or assign the plurality of images into one or more groups of images. As an example, images having a location indicator referring to a first location associated therewith are assigned into a first group of images, images having a location indicator referring to a second location associated therewith are assigned into a second group, etc. Consequently, an audio track to accompany a presentation of a group of images may be determined and/or composed separately for the each group of images, and the resulting audio tracks may be combined, e.g. concatenated, into a composition audio track to accompany a presentation of the plurality of images.

As an example, location indicator may be considered to refer to a certain location if it indicates location within a predefined maximum distance from a reference location associated with the certain location. As another example, location indicator may be considered to refer to a certain location if it indicates location within a reference area associated with the certain location. The reference area may be defined for example by a number of reference locations or reference points. The reference location or the reference area may be predetermined, or they may be determined based on the location information associated with one or more of the images of the plurality of images.

An image may have a time indicator associated therewith. A time indicator associated with an image may indicate for example the time of day and the date associated with the image. A time indicator associated with an image may indicate for example the time and date of capture of a photograph, or the time indicator may indicate the time and date otherwise associated with the image.

In accordance with an embodiment of the invention, the classification unit 16 may be configured to obtain a plurality of time indicators, each time indicator associated with an image of the plurality of images. A time indicator may indicate the time and date associated with an image, the classification unit 16 may be further configured to determine a first group of images as a subset of the plurality of images such that the first group of images comprises images having time indicator referring to a first period of time associated therewith. Moreover, the time indicators may be used to assign the images of the plurality of images into a number of groups along similar lines as described hereinbefore for the location indicator based grouping.

As an alternative grouping arrangement, the classification unit 16 may be configured to perform grouping of images based both on location indicators associated and time indicators associated therewith, for example in such a way that images having a location indicator referring to a first location and a time indicator referring to a first period of time associated therewith are assigned to a first group. Correspondingly, images having a location indicator referring to a second location and a time indicator referring to a second period of time associated therewith are assigned to a second group etc.

In accordance with an embodiment of the invention, the audio analysis unit 12 may be configured to determine, for each image of a group of images, a segment of audio signal associated therewith for determination of a respective intermediate audio signal. The audio analysis unit 12 may be further configured to determine, for each image of the group of images, an intermediate audio signal having duration matching or essentially matching the assigned viewing time of the respective image on basis of said determined segment of the audio signal associated therewith. Moreover, the audio track determination unit 14 may be configured to compose the audio track as concatenation of said intermediate audio signals to form an audio track having a duration covering or essentially covering the assigned overall viewing time of the group of images.

Hence, the audio analysis unit 12 may be configured determine, for each image of the group of images, a portion of the audio track temporally aligned with the viewing time of the respective image based on the audio signal associated with the respective image, and the audio track determination unit 14 may be configured to concatenate the portions of the audio track into a single audio track having a desired duration. A general principle of such determination of an audio track is illustrated in FIG. 3.

The determination of a segment of audio signal associated with an image and/or the determination of an intermediate audio signal on basis of said segment may comprise analysis of the audio signal for example with respect to the duration of and signal level within the audio signal. Alternatively or additionally, the analysis may comprise analysis of further audio-related information associated with the image.

An intermediate audio signal corresponding to a given image of the group of images may be determined as a predetermined portion of the audio signal associated with the given image, for example as a portion of desired duration in the beginning of the audio signal. In case the duration of the audio signal is shorter than the assigned viewing time of the given image, the respective intermediate audio signal may be determined for example as the audio signal repeated and/or partially repeated to reach a duration matching or essentially matching the assigned viewing time of the given image.

Alternatively, an intermediate audio signal corresponding to a given image of the group of images may be determined by modification of a predetermined portion of the audio signal associated with the given image or a segment thereof. Such modification may comprise for example signal level adjustment of the portion of the audio signal in order to result in an intermediate audio signal having a desired overall signal level. As another example, such modification may comprise signal level adjustment of a selected segment of the portion of the audio signal associated with the given image for example to implement cross-fading of desired characteristics between adjacent portions of the audio track.

In accordance with an embodiment of the invention, the audio analysis unit 12 may be configured to analyze at least one of the audio signals to determine whether an audio signal comprises a specific audio signal component. The audio analysis unit 12 may be further configured to determine, in response to determining that the audio signal associated with a given image comprises a specific audio component, an intermediate audio signal having duration matching or essentially matching the assigned viewing time of the given image. The intermediate audio signal hence corresponds to the given image, and the intermediate audio signal may be determined based at least in part on said specific audio component identified in the audio signal associated with the given image. This determination may involve extracting, e.g. copying, the identified specific audio component from the audio signal. Moreover, the audio track determination unit 14 may be configured to compose the audio track portion temporally aligned with the viewing time of the given image based at least in part on said intermediate audio signal.

Hence, the specific audio signal component identified in an audio signal associated with a given image of the group of images may be used as a portion of the audio signal associated with the given image to be used in determination of the audio track, in particular in determination of the portion of the audio track temporally aligned with the assigned viewing time of the given image.

The intermediate audio signal corresponding to the given image may be determined as the specific audio signal component as such or as the specific audio signal component combined to a predetermined audio signal or signals in order to determine an intermediate audio signal having the desired (temporal) length, i.e. desired duration. The combination may comprise for example mixing the specific audio signal component with a predetermined audio signal or concatenating the specific audio signal component to (copies of) one or more predetermined audio signals in order to have a signal of desired duration.

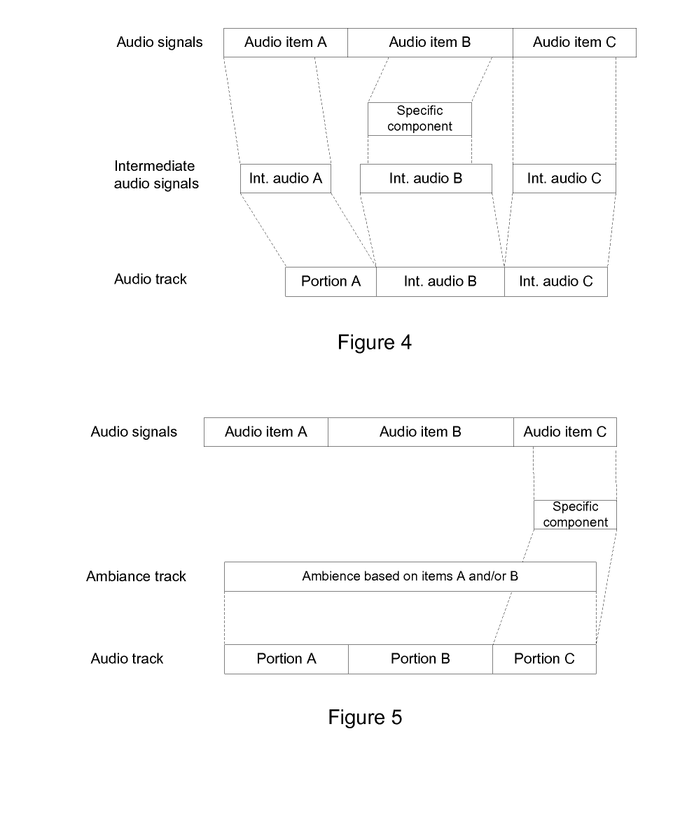

An example of composing a portion of an audio track based at least in part on a specific audio signal component is provided in FIG. 4.

The specific audio signal component may be for example a voice (or speech) signal component originating from a human subject, music, sound originating from an animal, a sound originating from a machine or any specific audio signal component having predetermined characteristics. In particular, the specific audio signal component may comprise a spatial audio signal, hence having a perceivable direction of arrival associated therewith. The perceivable direction of arrival of a spatial audio signal may be determinable based on two or more audio signals or based on a stereophonic or a multi-channel audio signal via analysis of interaural time difference(s) and/or interaural level difference(s) between the channels of the stereophonic or multi-channel audio signal.

As an example, the analysis of an audio signal to determine whether the audio signal comprises a specific signal component may comprise determining whether the audio signal comprises a voice or speech signal component. Such an analysis may comprise making use of speech recognition technology actually configured to interpret or recognize a voice or speech signal, but which as a side product may also be used to detect a presence of a speech or voice signal component. Alternatively or additionally, voice activity detection techniques commonly used e.g. in telecommunications enable determining whether a portion of an audio signal comprise a speech or voice component, hence providing a further example of an analysis tool for determining a presence of a speech or voice signal component within the audio signal.

A further example of analysis of the audio signal is determining a presence of a spatial audio signal and/or perceivable direction of arrival thereof, as already referred to hereinbefore. As an example, the analysis of channels of a two-channel or a multi-channel audio signal with respect to level and/or time differences between the channels may enable determination of the perceivable direction of arrival and hence an indication on a presence of a spatial audio signal component, whereas an indication that a perceivable direction of arrival is not possible to be determined at a reliable enough manner may indicate absence of a spatial audio signal component.

An image may further have image mode data associated therewith. As an example, the image mode data may comprise information indicating a format of the image, e.g. whether the image is in a portrait format, i.e. an image having a width smaller than its height, or in a landscape format, i.e. an image having a width greater than its height. As another example, in case of a photograph in particular, the image mode data may comprise information indicating the operation mode (i.e. the capture mode, the shooting mode, the profile, etc.), of the camera employed capturing the image. Such operation mode may be for example “portrait”, “person”, “view”, “sports”, “party”, “outdoor”, etc., thereby possibly providing an indication regarding a subject represented by the image.

In accordance with an embodiment of the invention, the audio analysis unit 12 may be configured to perform the analysis for determining a presence of a specific audio signal component based at least in part on image mode data associated with the images. As an example, image mode data indicating a portrait as the image format or e.g. “portrait”, “person”, etc. as an operation mode may be used as an indicator that a signal associated with the given image may comprise a specific audio signal component, such as a voice or speech signal component or a spatial audio signal. Consequently, in accordance with an embodiment of the invention, only audio signals associated with such images may be subjected to the analysis in order to determine a presence of a specific audio signal component. Alternatively, the audio analysis unit 12 may be configured to perform the analysis to determine whether an audio signal comprises a specific audio signal component for all audio signals of the group of audio signals or for a predetermined subset of the group of audio signals.

In accordance with an embodiment of the invention, the apparatus 10 comprises an image analysis unit 18. The image analysis unit 18 may be configured to analyze, in response to determining that the audio signal associated with a given image comprises a specific signal component, the given image to determine a presence and a position of a specific subject the given image. Furthermore, the audio track determination unit 12 may be configured to compose, in response to determining a presence of a specific subject in the given image, an intermediate audio signal on basis of the specific audio signal component such that the intermediate audio signal is provided as a spatial audio signal having perceivable direction of arrival corresponding to the determined position of the specific subject in said given image or as a signal comprising a (temporal) portion comprising a spatial audio component of having perceivable direction of arrival corresponding to the determined position of the specific subject in said given image.

In other words, a spatial audio signal having a perceivable direction of arrival may be generated for a portion of the audio track temporally aligned with the assigned viewing time of an image having audio signal comprising a specific audio signal component associated therewith and having a specific subject identified in the image data. The generation of spatial audio signal may comprise modifying the audio image, i.e. perceivable direction of arrival, of an audio signal already comprising a spatial audio signal component or modifying a non-spatial audio signal to introduce a spatial audio signal component. The former may involve adding two or more audio channels to a single-channel audio signal and processing the audio channels to have an interaural level difference(s) and/or an interaural time difference(s) corresponding to a spatial audio signal having a desired perceivable direction of arrival. The latter may involve modifying/processing the channels of the audio signal to have an interaural level difference(s) and/or an interaural time difference(s) corresponding to a spatial audio signal having a desired perceivable direction of arrival. Such processing/modification may be applied to the audio signal as a whole or only to the portion(s) of the audio signal comprising a specific audio signal component associated with the specific subject in the given image

A specific subject to be identified may be for example a human subject or a part thereof, in particular a human face. Thus, the data of the given image may be analyzed by using a suitable pattern recognition algorithm configured to detect e.g. a human face, a shape of a human figure, a shape of an animal or any suitable shape having predetermined characteristics. Furthermore, the position of the specific subject within the given image is also determined in order to enable determining and/or preparing a spatial audio signal having a perceivable direction of arrival matching or essentially matching the position of the specific subject within the given image. The presence and/or position of the specific subject may be stored or provided as further data associated with the respective image.

In accordance with an embodiment of the invention, the audio analysis unit 12 may be configured to analyze at least one of the audio signals associated with the images of the group of images to determine whether an audio signal comprises an ambient signal component. In particular, the audio analysis unit 12 may be configured to determine whether an audio signal or a portion thereof comprises an ambient signal component only without a specific audio signal component. The determination may further comprise extracting, e.g. copying, the ambience signal component from the audio signal to be used for generation of the ambiance track.

The audio analysis unit 12 may be further configured to determine or compose, in response to determining that a given audio signal comprises an ambient signal component, an ambiance track having a duration covering or essentially covering the assigned overall viewing time of the group of images. The ambiance track may be determined on basis of said ambient signal component. The audio analysis unit 12 may be configured to extract, e.g. to copy, the ambient signal component and/or provide the ambient signal component to the audio track determination unit 14. Moreover, the audio track determination unit 14 may be configured to compose the audio track on basis of the ambiance track and said one or more intermediate audio signal. The ambiance track may be considered as an intermediate audio signal for determination of the audio track.

In case the ambiance track is the only intermediate audio signal available, the audio track may be composed on basis of the ambiance track alone. In such a case the audio track may be composed for example as a copy of the ambiance track or as a modification of the ambiance track. Such modification may comprise for example signal level adjustment of the ambiance track or a portion thereof.

The composition of the audio track may comprise combining the ambiance track to one or more (other) intermediate audio signals. In particular, the composition of the audio track may comprise mixing the ambiance track with an intermediate audio signal determined on basis of a specific audio signal component identified in an audio signal associated with a given image such that the intermediate audio signal determined on basis of the specific audio signal component is temporally aligned with the assigned viewing time of the given image. Consequently, while a signal component originating from the ambiance track covers or essentially covers the assigned overall viewing time of the group of images, and hence the duration of the audio track, the intermediate audio signal determined on basis of a specific audio signal component identified in an audio signal associated with a given image is mixed in the temporal location of the ambiance track, and hence in the temporal location of the audio track, temporally aligned with the assigned viewing time of the given image. A general principle of composing an audio track in such a manner is provided in FIG. 5.

In accordance with an embodiment of the invention, the determination of an ambiance signal on basis of the audio signal associated with a first image of the group of images may comprise determining the ambiance signal based on the audio signal associated with said first given image or a portion thereof. In particular, the determination may comprise determining that the audio signal associated with said first image comprises an ambient signal component only without a specific signal component or that at least a portion of the audio signal comprises an ambient signal component only without a specific signal component.

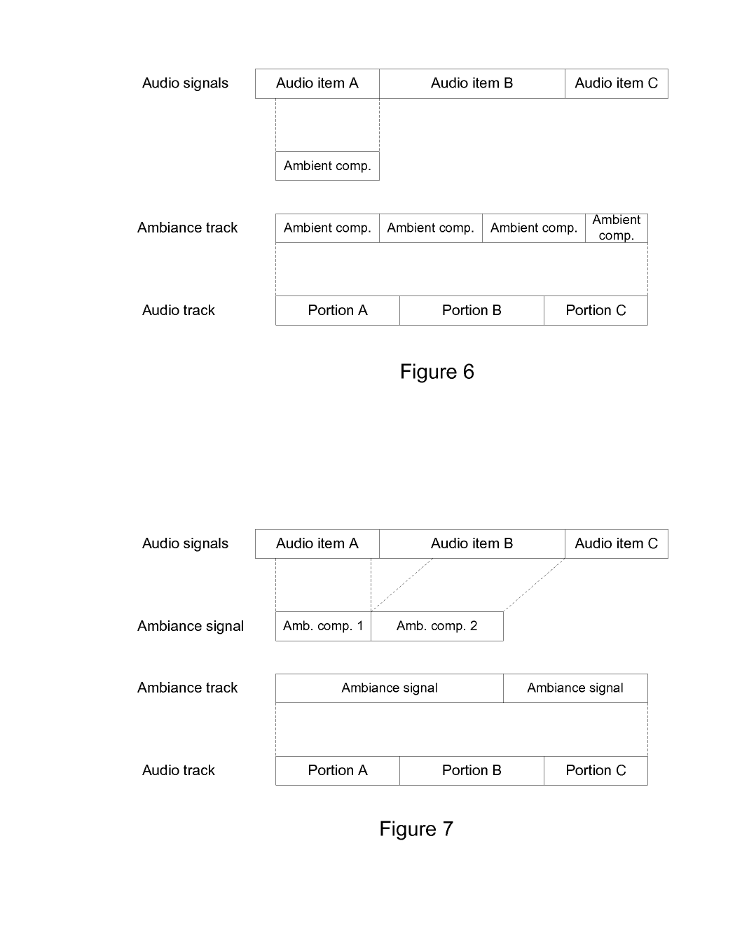

The determination of an ambiance track on basis of the ambient signal component may comprise using, e.g. extracting or copying, the ambient signal component as such, a selected portion of the ambient signal component, or the ambiance track may be determined as the ambient signal component as a whole or a selected part thereof repeated or partially repeated such as to cover the desired duration of the ambiance track. An example on the principle of determining or composing an ambiance track is illustrated in FIG. 6.

In accordance with an embodiment of the invention, the audio analysis unit 12 is configured to determine or compose, in response to determining that a second given audio signal comprises a second ambient signal component, the ambiance track having the duration covering or essentially covering the assigned overall viewing time of the group of images further on basis of said second ambient signal component.

The determination or composition of the ambiance track may hence be based on two, i.e. first and second, ambient signal components. The determination or composition may comprise determining the ambiance signal as combination of the first and second ambient signal components or portions thereof. The combination may involve concatenation of the two ambient signal components or potions thereof or mixing of the two ambient signal components or portions thereof to have an ambiance signal with desired duration or with desired audio characteristics, respectively. The determination of the ambiance signal may further comprise modifying the first ambient signal component or a portion thereof and/or modifying the second ambient signal component or a portion thereof. As an example, the modification may comprise adjusting the signal level of either or both of the audio signals or portions thereof to have a desired signal level of the ambiance signal. As another example, especially in case of an ambiance signal determined as a concatenation of the two ambient signal components, the modification may comprise level adjustment of a selected segment of either or both of the ambient signal components or portions thereof to implement cross-fading. The determination or composition of the ambiance signal based on two ambient signal components may be generalized to determination or composition of any number of ambiance signal components identified or extracted from a number of audio signals associated with the images of the group of images.

The determination of an ambiance track on basis of the ambiance signal may comprise using, e.g. extracting or copying, the ambiance signal as such, a selected portion of the ambiance signal, or the ambiance track may be determined as the ambiance signal as a whole or a selected part thereof repeated or partially repeated such as to cover the desired duration of the ambiance track. An example on the principle of determining or composing an ambiance track based on an ambiance signal is illustrated in FIG. 7.

As an example, the analysis of an audio signal to determine whether the audio signal comprises an ambient signal component may comprise determining whether the audio signal or a portion thereof exhibits predetermined audio characteristics indicating a presence of an ambient signal component. As an example of such predetermined audio characteristics, an audio signal or a portion thereof exhibiting stationary characteristics over time in terms of signal level and/or in terms of frequency characteristics may be considered to represent an ambient signal component. Alternatively or additionally, the analysis of an audio signal for determination of a presence of an ambient signal component may make use of the approaches for determining a presence of a specific signal component described hereinbefore: absence of a specific signal component in an audio signal or in a portion thereof may be considered to indicate that the respective audio signal or a portion thereof comprises an ambient signal component only.

In accordance with an embodiment of the invention, the analysis to determine whether an audio signal comprises an ambient signal component is based at least in part on image mode data that may be associated with images of the group of images.

As described hereinbefore, the image mode data associated with an image may indicate e.g. a format of an image or an operation mode of the capturing device employed for capturing the image. Consequently, image mode data indicating a landscape as the image format or e.g. “view”, “landscape”, etc. as an operation mode may be used as an indicator that an audio signal associated with the given image or a portion thereof may comprise an ambient signal component only without a specific signal component. Consequently, in accordance with an embodiment of the invention, only audio signals associated with such images may be subjected to the analysis for determination of a presence of an ambient signal component. Alternatively, the audio analysis unit 12 may be configured to perform the analysis to determine whether an audio signal comprises an ambient signal component for all audio signals of the group of audio signals or for a predetermined subset of the group of audio signals.

An image may have orientation data associated therewith. The orientation data may comprise information indicating an orientation of an image with respect to one or more reference points. As an example, the orientation data may comprise information indicating an orientation with respect to north or with respect to the magnetic north pole, hence indicating a compass direction or an estimate thereof. As another example, the orientation data may comprise information indicating an orientation of the image with respect to a horizontal plane, hence indicating a tilt of the image with respect to the horizontal plane.

As an example, orientation data associated with an image may be evaluated in order to assist determination of a direction of arrival associated with a spatial audio signal, in particular in analysis with respect the front/back confusion. Hence, as an example in this regard, the “shooting direction” of the camera that may be indicated by the orientation data may be employed in determination whether a spatial audio signal represents a sound coming from front side of the image or from back side of the image, in case there is any confusion in this regard. For example, the audio analysis unit 12 may be configured to use the orientation information to control analysis whether an audio signal comprises a specific audio signal: orientation information indicating an audio signal, and hence possibly a specific signal component, having a direction arrival on the back of the image may be used as an indication to exclude a given audio signal from the analysis. As another example, the image analysis unit 18 may be configured to use the orientation information to control analysis regarding a presence of a specific subject in an image: orientation information indicating an audio signal, and hence possibly a specific signal component, having a direction arrival on the back of the image may be used as an indication to exclude a given image from the analysis.

In accordance with various embodiments of the invention, items of further data associated with an image are used and considered. The further data may comprise sensory information and/or other information characterizing the image and/or providing further information associated with the image. The further data may be stored and/or provided together with the actual image data, for example by using a suitable storage or container format enabling storage/provision of both the (digital) image data and the further data. Alternatively the further data may be stored or provided as one or more separate data elements linked with the respective image data, arranged for example into a suitable database.

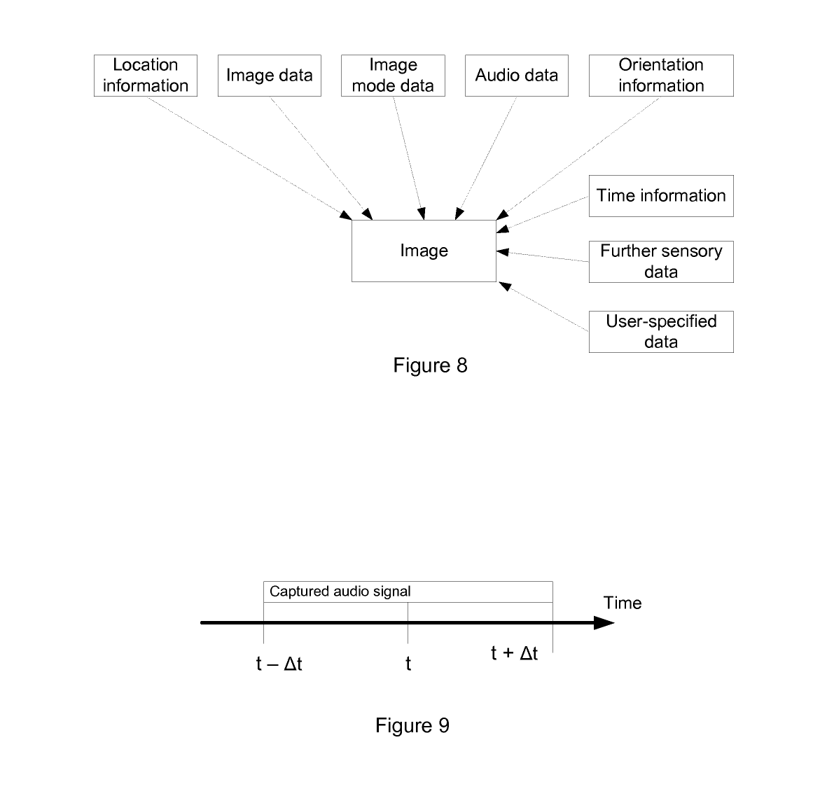

An example provided in FIG. 8 illustrates the concept of further data associated with an image indicating various examples of the further data items associated with an image, some of which are described hereinbefore.

As an example, an image of the plurality of images may originate from an apparatus or a device capable of capturing an image, in particular a digital image. Such an apparatus or a device may be for example, a camera or a video camera, in particular a digital camera or a digital video camera. As another example, an image may originate from an apparatus or a device equipped with a possibility to capture (digital) images. Examples of such an apparatus or a device include a mobile phone, a laptop computer, a desktop computer, a personal digital assistant (PDA), an internet tablet, etc. equipped with or connected to a camera, a video camera, a camera module, a video camera module or another arrangement enabling capture of digital images.

A device capable of capturing an image may be further equipped to and configured to capture or record, store and/or provide information that may be used as further data associate with the image, as described hereinbefore.

A device capable of capturing an image may be further provided with equipment enabling determination of the current location, and the device may be configured to determine the current location of the device upon capturing an image. Moreover, the device may be configured to store and/or provide the current location as information determining a location associated with the captured image.

As an example, the device may be further provided with audio recording equipment enabling capture of audio signal, and the device may be configured to capture one or more audio signals at or around the time of capturing an image. A captured audio signal may be monaural, stereophonic, or multi-channel audio signal and the audio signal may represent spatial audio signal. The device may be further configured to store and/or provide the one or more captured audio signals as one or more audio data items associated with the captured image.

The audio recording equipment may comprise for example one or more microphones, a directional microphone or a microphone array. As an example of an arrangement employing one or more microphones, the camera or the device may be provided with three or more microphones in a predetermined configuration. Based on the three or more audio signal captured by the three or more microphones and on knowledge regarding the predetermined microphone configuration it is possible to determine e.g. the phase difference between the three or more audio signals and, consequently, derive the direction of arrival of a sound represented by the three or more captured audio signals. This approach is similar to normal human hearing, where the localization of sound, i.e. the perceivable direction of arrival, is based in part on interaural time difference (ITD) between the left and right ears. Similar principle of operation may be applied also in case of a microphone array.

The device may equipped with so-called pre-record function enabling starting of capture of an audio signal even before the capture of the image, and the device may be configured to capture one or more audio signals using the prerecord function. FIG. 9 illustrates the principle of the pre-record function. The time of the capture of the image is indicated by time t, whereas time t−Δt indicates the start of the capture of an audio signal and time t+Δt indicates the end of the capture of the audio signal. The audio capture before time t may be implemented for example by configuring the audio recording equipment of the device to constantly record and buffer audio signal such that the period of time between t−Δt and t can be covered. In the example of FIG. 9 equal audio capture durations before and after the capture time t of the image are indicated. However, in other examples the audio capture duration before the capture time t of the image may be shorter or longer than the audio capture duration after time t.

A device capable of capturing an image may be further provided with equipment enabling capture of image mode data associated with an image, and the device may be configured to capture the current image mode upon capturing an image. Moreover, the device may be configured to store and/or provide the captured current image mode as an image mode associated with the captured image.

A device capable of capturing an image may be further provided with equipment enabling capture of orientation data associated with an image, and the device may be configured to capture the current orientation of the device upon capturing an image. Moreover, the device may be configured to store and/or provide the captured current orientation of the device as information indicating an orientation of an image with respect to one or more reference points associated with the capture image. As an example, the equipment enabling capture of orientation data may comprise a compass. As another example, the equipment enabling capture of orientation data may comprise one or more accelerometers configured to keep track of the current orientation of the device. As a further example, the equipment enabling capture of orientation data may comprise one or more receivers or transceivers enabling determination of the current location based on one or more received radio signals originating from known (separate) locations.

A device capable of capturing an image may be further provided with equipment enabling capture of current time, and the device may be configured to capture the current time upon capturing an image. Moreover, the device may be configured to store and/or provide the captured current time as a time indicator associated with the capture image. Such a time indicator may indicate for example the time of day and the date associated with the image.

Instead of capturing or recording a data item of further data associated with an image together and/or at the time of capturing the image, for example by using a device capable of capturing an image equipped with an arrangement enabling the capture or recording of the respective item of further data, the data item of further data associated with an image may be introduced separately from the capture of the image. Hence, as a few examples, an image may be associated with location information, audio data, image mode data and/or orientation data that is not directly related to the capture of the image. This may be particularly useful in case of images other than photographs, such as drawings, graphs, computer generated images, etc. In particular, any user-specified data associated with an image may be introduced separately from the capture of the image. Moreover, it is possible to modify or replace one or more of the data items of further data associated with an image introduced for example by using a device capable of capturing an image equipped with an arrangement enabling the capture or recording of the respective item of further data.

Apparatuses according to various embodiments of the invention are described hereinbefore using structural terms. The procedures assigned in the above to a number of structural units, i.e. to the audio analysis unit 12, to the audio track determination unit 14, to the classification unit 16 and/or to the image analysis unit 18, may be assigned to the units in a different manner, or there may be further units to perform some of the procedures described in context of various embodiments of the invention described hereinbefore. In particular, the procedures assigned hereinbefore to the audio analysis unit 12, to the audio track determination unit 14, to the classification unit 16 and/or to the image analysis unit 18 may be assigned to a single processing unit of the apparatus 10 instead. In accordance of a further embodiment of the invention, expressed in functional terms, an audio processing apparatus is provided, the apparatus comprising means for obtaining a group of audio signals, each audio signal associated with an image of a group of images, the group of images being provided for a presentation having an assigned overall viewing time with each image having an assigned viewing time, means for analyzing at least one of the audio signals to determine one or more intermediate audio signals for determination of an audio track having a first duration, which first duration essentially covers said assigned overall viewing time; and means for composing the audio track having said first duration on basis of said one or more intermediate audio signals.

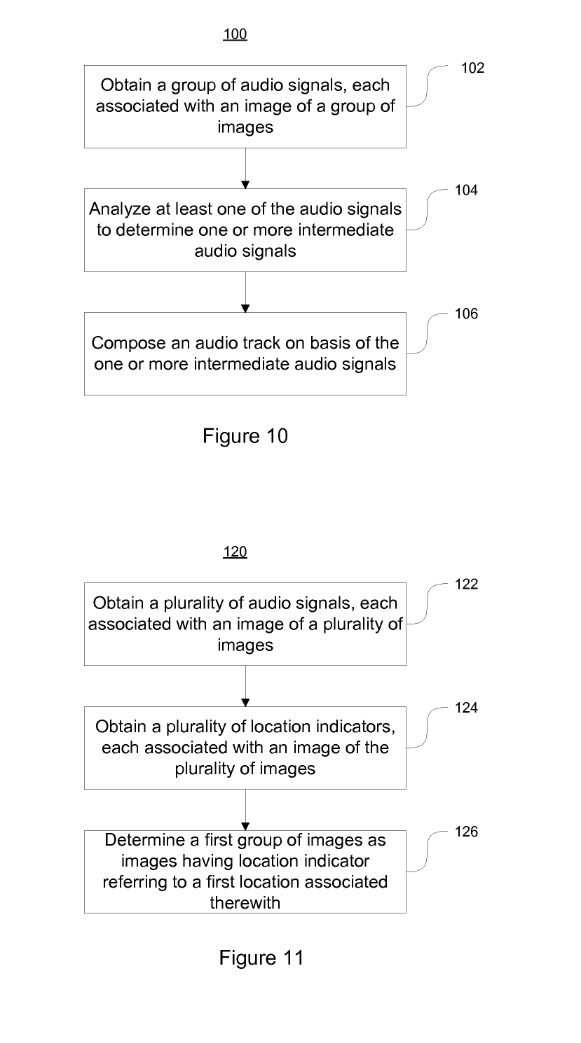

A method 100 in accordance with an embodiment of the invention is illustrated in FIG. 10. The method 100 comprises obtaining a group of audio signals, each audio signal associated with an image of a group of images, the group of images being provided for a presentation having an assigned overall viewing time with each image having an assigned viewing time, as indicated in step 102. The method 100 further comprises analyzing at least one of the audio signals to determine one or more intermediate audio signals for determination of an audio track having a first duration, which first duration essentially covers said assigned overall viewing time, as indicated in step 104. The method 100 further comprises composing the audio track having said first duration on basis of said one or more intermediate audio signals, as indicated in step 106.

A method 120 in accordance with an embodiment of the invention is illustrated in FIG. 11. The method 120 comprises obtaining a plurality of audio signals, each audio signal associated with an image of a plurality of images, as indicated in step 122. The method 120 further comprises obtaining a plurality of location indicators, each location indicator associated with an image of the plurality of images, as indicated in step 124. The method 120 further comprises determining a first group of images as a subset of the plurality of images such that the first group comprises images having location indicator referring to a first location associated therewith, as indicated in step 124. Said first group of images may be processed for example in accordance with the method 100 described hereinbefore.

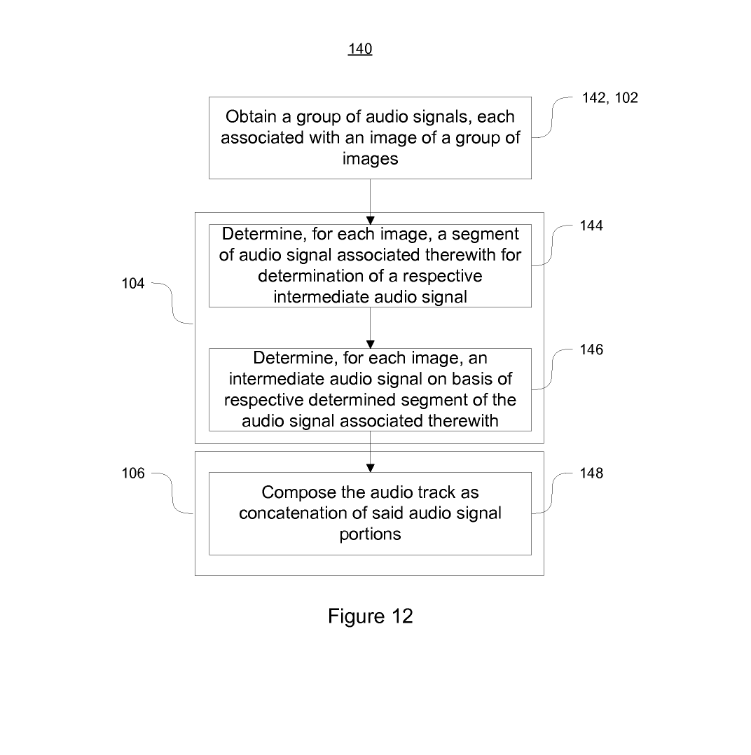

A method 140 in accordance with an embodiment of the invention is illustrated in FIG. 12. The method 140 comprises obtaining a group of audio signals, each audio signal associated with an image of a group of images, the group of images being provided for a presentation having an assigned overall viewing time with each image having an assigned viewing time, as indicated in step 142. The method 140 further comprises determining, for each of the images, a segment of audio signal associated therewith for determination of a respective intermediate audio signal, as indicated in step 144, and determining, for each of the images, an intermediate audio signal having duration essentially matching the assigned viewing time of the respective image on basis of said determined segment of the audio signal associated therewith, as indicated in step 146. The method 140 further comprises composing the audio track as concatenation of said intermediate audio signals, as indicated in step 148.

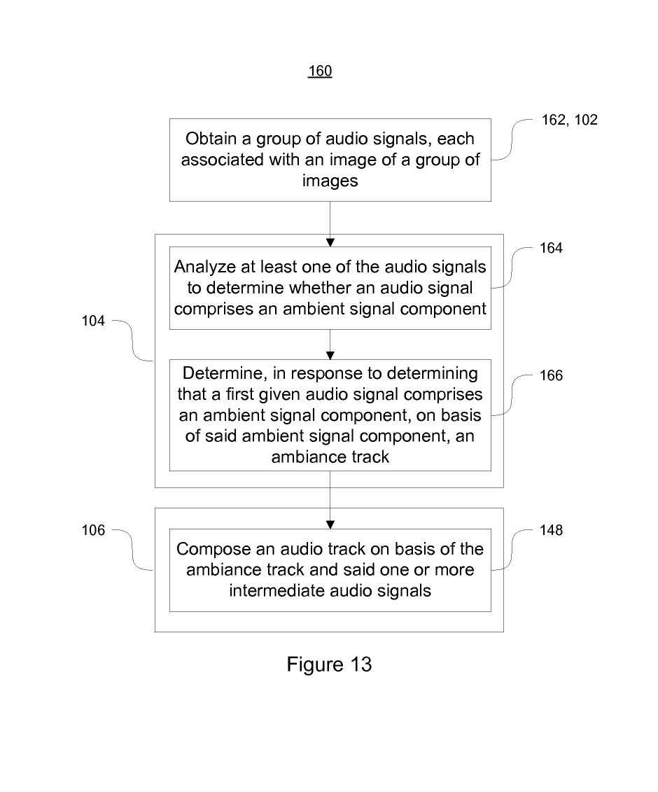

A method 160 in accordance with an embodiment of the invention is illustrated in FIG. 13. The method 160 comprises obtaining a group of audio signals, each audio signal associated with an image of a group of images, the group of images being provided for a presentation having an assigned overall viewing time with each image having an assigned viewing time, as indicated in step 162. The method 160 comprises analyzing at least one of the audio signals to determine whether an audio signal comprises an ambient signal component, as indicated in step 164. The method 160 further comprises determining, in response to determining that a first given audio signal comprises an ambient signal component, an ambiance track having a duration covering or essentially covering the assigned overall viewing time of the group of images, the ambiance track being determined on basis of said ambient signal component, as indicated in step 166. The method 160 further comprises composing the audio track on basis of the ambiance track and said one or more intermediate audio signals, as indicated in step 168.

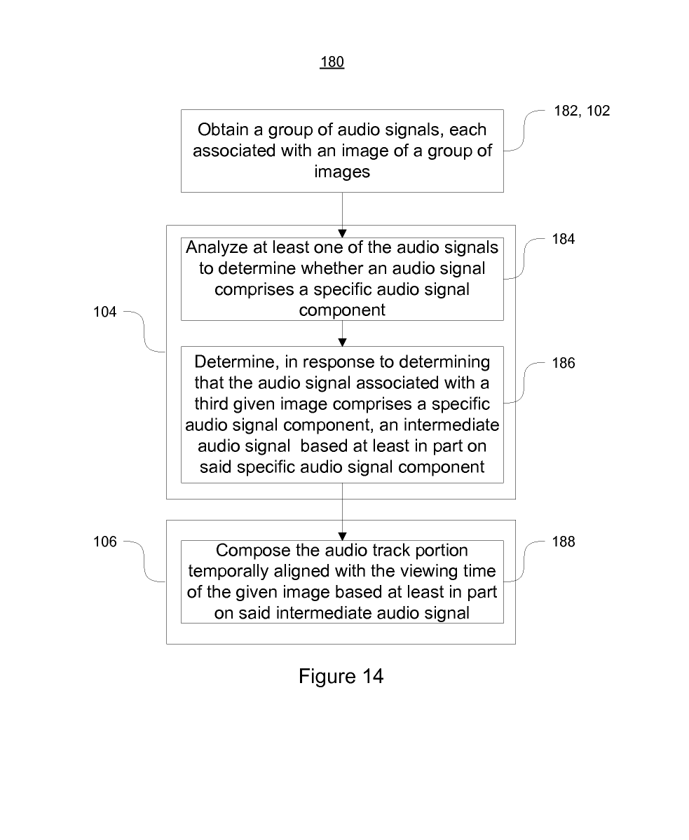

A method 180 in accordance with an embodiment of the invention is illustrated in FIG. 14. The method 180 comprises obtaining a group of audio signals, each audio signal associated with an image of a group of images, the group of images being provided for a presentation having an assigned overall viewing time with each image having an assigned viewing time, as indicated in step 182. The method 180 comprises analyzing at least one of the audio signals to determine whether an audio signal comprises a specific audio signal component, as indicated in step 184. The method 180 further comprises determining, in response to determining that the audio signal associated with a given image comprises a specific audio signal component, an intermediate audio signal having duration essentially matching the assigned viewing time of the given image based at least in part on said specific audio signal component; as indicated in step 186. The method 180 further comprises composing the audio track portion temporally aligned with the viewing time of the given image based at least in part on said intermediate audio signal.

In the following, a further exemplifying embodiment of the invention is disclosed.

In accordance with an embodiment the invention, a plurality of images, each of the images associated with location indicator is obtained. Moreover, each of the images of the plurality of images is further associated with an audio signal. Each image of the plurality of images may be further associated with orientation data and with other sensory data descriptive of the conditions associated with the capture of the respective image.

The images of the plurality of images are presented to a user, for example on a display screen of a computer or a camera, and the user makes a selection of images to be included in a presentation. The presentation may be for example a slide show, in which the images are shown to a viewer of the slide show one by one, each image to be presented for a viewing time or duration assigned thereto.

During or after the selection of the images for presentation the assigned viewing time for each of the images is obtained. The assigned viewing time for a given image selected for the presentation may be pre-assigned and obtained as further data associated with the given image. Alternatively, the user may assign a desired viewing time for each of the images selected for the presentation, e.g. upon selection of the respective image for the presentation.

Determination of an audio track to accompany the presentation of the images selected for presentation as a slide show comprises grouping the images selected for presentation into a number of groups based on the location indicators associated with the images: images referring to the same location or to an area that can be considered to represent the same location are assigned to the same group. Once the images selected for presentation are assigned into a suitable number of groups, each group is processed separately.

For a given group, the audio signals associated with the images assigned to the given group are processed by an analysis algorithm in order to detect a speech or voice signal as a specific audio signal component within the respective audio signal. In response to detecting a speech or voice signal in an audio signal, the speech/voice signal may be extracted for later use in composition of the audio track for the given group. Similarly, audio signals associated with the images of the given group are processed to identify images having ambient signal component only included therein. In response to detecting an ambient signal component only in an audio signal, the ambient signal component may be extracted for later use in composition of an ambient track for the given group.

The images having audio signals found to include a speech or voice signal component associated therewith are processed by an image analysis algorithm in order to detect human subjects of parts thereof, for example human faces, and their locations within the respective images. Consequently, in response to detecting a human subject or a part thereof in an image, the respective image may be provided with an identifier, e.g. a tag, indicating the presence of a human subject in the image. The identifier, or the tag, may also include information specifying the location of the identified human subject within the image. The identifier may be included (e.g. stored or provided) as further data associated with respective image. The analysis for the images found to present a human subject may further comprise analyzing the audio signal associated therewith in order to detect a spatial audio signal component, and possibly modify the spatial audio component in order to have an audio image representing a desired perceivable direction of arrival. Alternatively, the audio signal associated with an image found to include a human subject may be modified into a spatial audio signal, and indication of a presence spatial audio signal component may be included in the further audio-related information associated with the audio signal, possibly together with information indicating the perceivable direction of the spatial audio signal component.

The above-mentioned analysis algorithms may be adaptive or responsive to image mode data associated with an image, for example in such a way that image mode data indicating a portrait format for an image or a camera mode or profile suggesting a human subject in the image are, primarily or exclusively, considered as images potentially having a speech or voice signal component and/or a spatial audio signal component included in the audio signal associated therewith. In contrast, image mode data indicating a landscape format or a camera mode suggesting a view or scenery to be included in the image are, primarily or exclusively, considered as images potentially having an ambient signal component only included in the audio signal associated therewith.

Once all the groups have been analyzed for speech or voice components and ambient signal components, an ambient track is generated for each of the groups. The ambient track for a given group is composed based on ambient signal components identified, and possibly extracted, for the given group. For a given group of images, an ambiance track having an overall duration matching the sum of assigned viewing times of the images assigned for the given group is generated. The ambiance track may be generated on basis of the ambient signal components identified in one or more audio signals associated with the images assigned for the given group, as described in detail hereinbefore.

Once the ambiance track for a given group is generated, the speech/voice signal components possibly identified, and possibly extracted, from audio signals associated with certain images assigned for the given group are mixed with the ambiance track to generate the audio track for the given group. The speech or audio signal components are mixed in the audio track in temporal locations corresponding to the assigned viewing times of the images with which the respective speech or audio signal components are associated.

Once the audio tracks for all groups of images have been generated, a composition audio track to accompany the presentation of the images selected for presentation is generated by concatenating the audio tracks into a composition audio track.

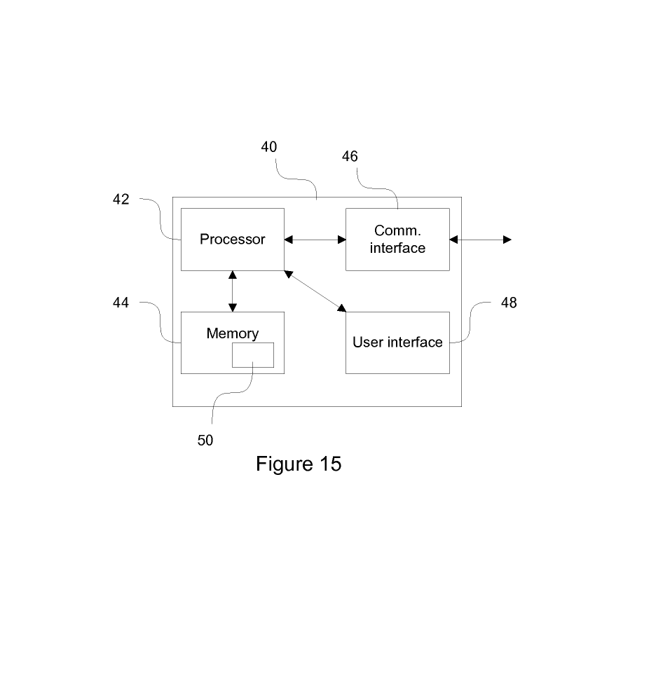

FIG. 15 schematically illustrates an apparatus 40 in accordance with an embodiment of the invention. The apparatus 40 may be used as an audio processing apparatus 10. The apparatus 40 may be an end-product or a module, the term module referring to a unit or an apparatus that excludes certain parts or components that may be introduced by an end-manufacturer or by a user to result in an apparatus forming an end-product.

The apparatus 40 may be implemented as hardware alone (e.g. a circuit, a programmable or non-programmable processor, etc.), the apparatus 40 may have certain aspects implemented as software (e.g. firmware) alone or can be implemented as a combination of hardware and software.

The apparatus 40 may be implemented using instructions that enable hardware functionality, for example, by using executable computer program instructions in a general-purpose or special-purpose processor that may be stored on a computer readable storage medium (disk, memory etc) to be executed by such a processor.

In the example of FIG. 15 the apparatus 40 comprises a processor 42, a memory 44 and a communication interface 46, such as a network card or a network adapter enabling wireless or wireline communication with another apparatus. The processor 42 is configured to read from and write to the memory 44. The apparatus 40 may further comprise a user interface 48 for providing data, commands and/or other input to the processor 42 and/or for receiving data or other output from the processor 42, the user interfaces comprising for example one or more of a display, a keyboard or keys, a mouse or a respective pointing device, a touchscreen, etc. The apparatus may comprise further components not illustrated in the example of FIG. 15.

Although the processor 42 is presented in the example of FIG. 15 as single component, the processor 42, it may be implemented as one or more separate components. Although the memory 44 in the example of FIG. 15 is illustrated as a single component, it may be implemented as one or more separate components some or all of which may be integrated/removable and/or may provide permanent/semi-permanent/dynamic/cached storage

The apparatus 40 may be embodied for example as a mobile phone, a camera, a video camera, a music player, a gaming device, a laptop computer, a desktop computer, a personal digital assistant (PDA), an internet tablet, a television set, etc.

The memory 44 may store a computer program 50 comprising computer-executable instructions that control the operation of the apparatus 40 when loaded into the processor 42. As an example, the computer program 50 may include one or more sequences of one or more instructions. The computer program 50 may be provided as a computer program code. The processor 42 is able to load and execute the computer program 50 by reading the one or more sequences of one or more instructions included therein from the memory 44. The one or more sequences of one or more instructions may be configured to, when executed by one or more processors, cause an apparatus, for example the apparatus 40, to implement processing according to one or more embodiments of the invention described hereinbefore.

Hence, the apparatus 40 may comprise at least one processor 42 and at least one memory 44 including computer program code for one or more programs, the at least one memory 44 and the computer program code configured to, with the at least one processor 42, cause the apparatus 40 to perform processing in accordance with one or more embodiments of the invention described hereinbefore.

The computer program 50 may be provided at the apparatus 40 via any suitable delivery mechanism. As an example, the delivery mechanism may comprise at least one computer readable non-transitory medium having program code stored thereon, the program code which when executed by an apparatus cause the apparatus at least implement processing in accordance with an embodiment of the invention, such as any of the methods 100, 120, 140, 160 and 180 described hereinbefore The delivery mechanism may be for example a computer readable storage medium, a computer program product, a memory device a record medium such as a CD-ROM or DVD, an article of manufacture that tangibly embodies the computer program 50. As a further example, the delivery mechanism may be a signal configured to reliably transfer the computer program 50.

Reference to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1-78. (canceled)

79. A method comprising
obtaining a group of audio signals, each audio signal associated with an image of a group of images, the group of images being provided for a presentation having an assigned overall viewing time with each image having an assigned viewing time,
analyzing at least one of the audio signals to determine one or more intermediate audio signals for determination of an audio track having a first duration, which first duration essentially covers said assigned overall viewing time; and
composing the audio track having said first duration on basis of said one or more intermediate audio signals.

80. A method according to claim 79, further comprising
obtaining a plurality of audio signals, each audio signal associated with an image of a plurality of images,
obtaining a plurality of location indicators, each location indicator associated with an image of the plurality of images, and
determining the first group of images as a subset of the plurality of images such that the first group comprises images having location indicator referring to a first location associated therewith.

81. A method according to claim 80, wherein the location information comprises global positioning system coordinates.

82. A method according to claim 80, wherein the first location is determined by a predefined maximum distance from a predetermined reference location.

83. A method according to claim 79,
wherein said analysis of at least one of the audio signals comprises
determining, for each of the images, a segment of audio signal associated therewith for determination of a respective intermediate audio signal, and
determining, for each of the images, an intermediate audio signal having duration essentially matching the assigned viewing time of the respective image on basis of said determined segment of the audio signal associated therewith; and
wherein said composing comprises composing the audio track as concatenation of said intermediate audio signals.

84. A method according to claim 79,
wherein said analysis of at least one of the audio signals comprises
analyzing at least one of the audio signals to determine whether an audio signal comprises an ambient signal component, and
determining, in response to determining that a first given audio signal comprises an ambient signal component, an ambiance track having the first duration, the ambiance track being determined on basis of said ambient signal component; and
wherein said composing comprises composing the audio track on basis of the ambiance track and said one or more intermediate audio signals.

85. A method according to claim 84, wherein said analysis of at least one of the audio signals comprises determining, in response to determining that a second given audio signal comprises a second ambient signal component, the ambiance track having the first duration further on basis of said second ambient signal component.

86. A method according to claim 84, wherein the analysis of at least one of the audio signals to determine whether an audio signal comprises an ambient signal component is based at least in part on image mode data associated with the respective image.

87. A method according to claim 86, wherein said image mode data is indicative of operation mode of a camera from which the respective image originates.

88. A method according to claim 79,
wherein said analysis of at least one of the audio signals comprises
analyzing at least one of the audio signals to determine whether an audio signal comprises a specific audio signal component, and
determining, in response to determining that the audio signal associated with a third given image comprises a specific audio signal component, an intermediate audio signal having duration essentially matching the assigned viewing time of the third given image based at least in part on said specific audio signal component; and
wherein said composing comprises composing the audio track portion temporally aligned with the viewing time of the third given image based at least in part on said intermediate audio signal.

89. A method according claim 88, wherein said analysis of at least one of the audio signals to determine whether an audio signal comprises a specific audio signal component is based at least in part on image mode data associated with images of the group of images.

90. A method according to claim 88, further comprising
analyzing, in response to determining that the audio signal associated with the third given image comprises a specific signal component, the third given image to determine a presence and a position of a specific subject the third given image, and
wherein said composing comprises composing, in response to determining a presence of a specific subject in the third given image, an intermediate audio signal on basis of the specific audio signal component as a spatial audio signal having perceivable direction of arrival corresponding to the determined position of the specific subject in said third given image.

91. An apparatus comprising at least one processor and at least one memory including computer program code for one or more programs, the at least one memory and the computer program code configured to, with the at least one processor, cause the apparatus to perform at least the following:
obtain a group of audio signals, each audio signal associated with an image of a group of images, the group of images being provided for a presentation having an assigned overall viewing time with each image having an assigned viewing time,
analyze at least one of the audio signals to determine one or more intermediate audio signals for determination of an audio track having a first duration, which first duration essentially covers said assigned overall viewing time; and
compose the audio track having said first duration on basis of said one or more intermediate audio signals.

92. An apparatus according to claim 91, wherein the computer executable instructions are further configured to, when executed by the processor, cause the apparatus to
obtain a plurality of audio signals, each audio signal associated with an image of a plurality of images,
obtain a plurality of location indicators, each location indicator associated with an image of the plurality of images, and
determine the group of images as a subset of the plurality of images such that the group comprises images having location indicator referring to a first location associated therewith.

93. An apparatus according to claim 92, wherein the location information comprises global positioning system coordinates.

94. An apparatus according to claim 92, wherein the first location is determined by a predefined maximum distance from a predetermined reference location.

95. An apparatus according to claim 91,
wherein said analyzing at least one of the audio signals comprises
determining, for each of the images, a segment of audio signal associated therewith for determination of a respective intermediate audio signal, and
determining, for each of the images, an intermediate audio signal having duration essentially matching the assigned viewing time of the respective image on basis of said determined segment of the audio signal associated therewith; and
wherein said composing comprises composing the audio track as concatenation of said intermediate audio signals.

96. An apparatus according to claim 91,
wherein said analyzing at least one of the audio signals comprises
analyzing at least one of the audio signals to determine whether an audio signal comprises an ambient signal component, and
determining, in response to determining that a first given audio signal comprises an ambient signal component, an ambiance track having the first duration, the ambiance track being determined on basis of said ambient signal component; and
wherein said composing comprises composing the audio track on basis of the ambiance track and said one or more intermediate audio signals.

97. An apparatus according to claim 96, wherein said analyzing at least one of the audio signals to determine whether an audio signal comprises an ambient signal component is performed in dependence on image mode data associated with images of the group of images.

98. A computer program product comprising at least one computer readable non-transitory medium having program code stored thereon, the program which when executed by an apparatus cause the apparatus at least to
obtain a group of audio signals, each audio signal associated with an image of a group of images, the group of images being provided for a presentation having an assigned overall viewing time with each image having an assigned viewing time,
analyze at least one of the audio signals to determine one or more intermediate audio signals for determination of an audio track having a first duration, which first duration essentially covers said assigned overall viewing time; and
compose the audio track having said first duration on basis of said one or more intermediate audio signals.
